(19) United States
(12) Patent Application Publication
(10) Pub. No.: US 2021/0182679 A1
(43) Pub. Date: Jun. 17, 2021

(54) DATA PROCESSING SYSTEM AND DATA PROCESSING METHOD

(71) Applicant: OLYMPUS CORPORATION, Tokyo (JP)

(72) Inventor: Yoichi YAGUCHI, Tokyo (JP)

(73) Assignee: OLYMPUS CORPORATION, Tokyo (JP)

(21) Appl. No.: 17/185,825

(22) Filed: Feb. 25, 2021

Related U.S. Application Data
(63) Continuation of application No. PCT/JP2018/032484, filed on Aug. 31, 2018.

(51) Int. Cl. G06N 3/08

(52) U.S. Cl. CPC G06N 3/08

(57) ABSTRACT

A data processing system includes: a neural network processing unit that performs a process determined by a neural network including an input layer, one or more intermediate layers, and an output layer; and a learning unit that trains the neural network by optimizing an optimization parameter of the neural network based on a comparison between output data output when the neural network processing unit subjects learning data to the process determined by the neural network and ideal output data for the learning data. The neural network processing unit performs, in a learning process, a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

### CROSS-REFERENCE TO RELATED APPLICATIONS

This application is based upon and claims the benefit of priority from International Application No. PCT/JP2018/032484, filed on Aug. 31, 2018, the entire contents of which is incorporated herein by reference.

### BACKGROUND OF THE INVENTION

### 1. Field of the Invention

The present invention relates to data processing technologies and, more particularly, to a data processing technology that uses a trained deep neural network.

### 2. Description of the Related Art

A neural network is a mathematical model including one or more non-linear units and is a machine learning model that predicts an output corresponding to an input. A majority of neural networks include one or more intermediate layers (hidden layers) other than the input layer and the output layer. The output of each intermediate layer represents an input to the next layer (the intermediate layer or the output layer). Each layer of the neural network generates an output according to the input and the parameter of the layer.

### Non-Patent Literature 1

Alex Krizhevsky, Ilya Sutskever, Geoffrey E. Hinton, “ImageNet Classification with Deep Convolutional Neural Networks”, NIPS2012_4824

### Non-Patent Literature 2

It is Sergey Ioffe, Christian Szegedy, “Batch normalization: Accelerating deep network training by reducing internal covariate shift”, ICML 2015 448-456

Generally, a significant change in the relationship between the input and the output of a network as a whole makes learning difficult. Non-patent literature 2 teaches resolving the difficulty of learning by inhibiting the relationship between the input and the output from changing significantly by normalizing an input to the next layer by utilizing the statistic of an input minibatch. However, excessive normalization leads to reduction in the expressive power of the network. Meanwhile, the problem associated with significant change in the relationship between the input and the output of the network as a whole is prominent in the initial phase of learning when the amount of updates to the parameters of the intermediate layers is large.

### SUMMARY OF THE INVENTION

The present invention addresses the above-described issue, and a general purpose thereof is to provide a technology that facilitates learning in a neural network.

A data processing system according to an embodiment of the present invention includes: a neural network processing unit that performs a process determined by a neural network including an input layer, one or more intermediate layers, and an output layer; and a learning unit that trains the neural network by optimizing an optimization parameter of the neural network based on a comparison between output data output when the neural network processing unit subjects learning data to the process and ideal output data for the learning data. The neural network processing unit performs, in a learning process, a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

Another embodiment of the present invention also relates to a data processing system. The data processing system includes a neural network processing unit that performs a process determined by a neural network including an input layer, one or more intermediate layers, and an output layer. The neural network processing unit is trained by optimizing an optimization parameter of the neural network based on a comparison between output data output when learning data is subject to the process and ideal output data for the learning data, and, in a learning process, the neural network processing unit performs a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

Another embodiment of the present invention relates to a data processing method. The method includes: outputting, by subjecting learning data to a process determined by a neural network, output data responsive to the learning data, the neural network including an input layer, one or more intermediate layers, and an output layer; and optimizing an optimization parameter of the neural network based on a comparison between the output data responsive to the learning data and ideal output data for the learning data.

Optimizing the optimization parameter includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

Another embodiment of the present invention also relates to a data processing method. The method includes performing a process determined by a neural network including an input layer, one or more intermediate layers, and an output layer. An optimization parameter of the neural network is optimized based on a comparison between output data output when learning data is subject to the process and ideal output data for the learning data, and training includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the function and configuration of a data processing system according to an embodiment;

FIG. 2 schematically shows an example of the configuration of the neural network;

FIG. 3 is a flowchart showing the learning process performed by the data processing system;

FIG. 4 is a flowchart showing the application process performed by the data processing system; and

FIG. 5 schematically shows another example of the configuration of the neural network.

### DETAILED DESCRIPTION OF THE INVENTION

The invention will now be described by reference to the preferred embodiments. This does not intend to limit the scope of the present invention, but to exemplify the invention.

Hereinafter, the invention will be described based on preferred embodiments with reference to the accompanying drawings.

A description will be given below of a case where the data processing apparatus is applied to image processing, but it would be understood by those skilled in the art that the data processing apparatus can also be applied to sound recognition process, natural language process, and other processes.

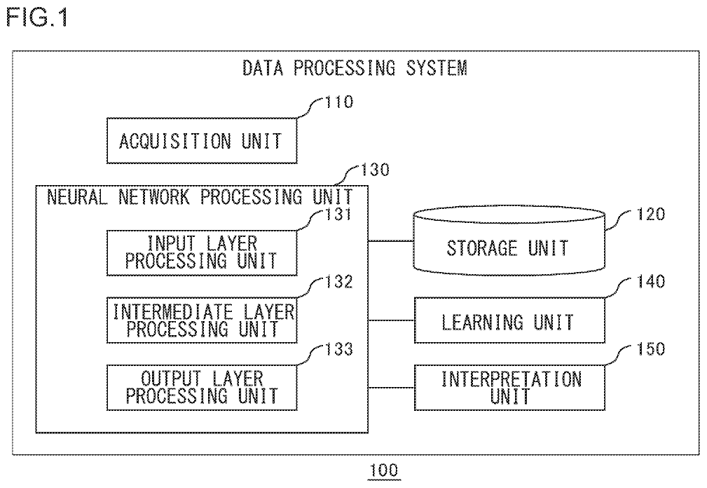

FIG. 1 is a block diagram showing the function and configuration of a data processing system 100 according to an embodiment. The blocks depicted here are implemented in hardware such as devices and mechanical apparatus exemplified by a CPU of a computer, and in software such as a computer program. FIG. 1 depicts functional blocks implemented by the cooperation of these elements. Therefore, it will be understood by those skilled in the art that the functional blocks may be implemented in a variety of manners by a combination of hardware and software.

The data processing system 100 performs a “learning process” of training a neural network based on an image for learning (learning data) and a ground truth value, which represents ideal output data for the image. The data processing system 100 also performs an “application process” of applying a trained neural network to an unknown image (unknown data) and performing image processes such as image categorization, object detection, or image segmentation.

In the learning process, the data processing system 100 subjects an image for learning to a process determined by the neural network and outputs output data responsive to the image for learning. The data processing system 100 updates a parameter (hereinafter, “optimization parameter”) of the neural network optimized (trained) in a direction in which the output data approaches the ground truth value. The optimization parameter is optimized by repeating the above steps.

In the application process, the data processing system 100 uses the optimization parameter optimized in the learning process to subject an unknown image to a process determined by the neural network and outputs output data responsive to the image. The data processing system 100 interprets the output data to categorize the image, detect an object in the image, or subject the image to image segmentation.

The data processing system 100 includes an acquisition unit 110, a storage unit 120, a neural network processing unit 130, a learning unit 140, and an interpretation unit 150. The function of the learning process is mainly implemented by the neural network processing unit 130 and the learning unit 140, and the function of the application process is mainly implemented by the neural network processing unit 130 and the interpretation unit 150.

In the learning process, the acquisition unit 110 acquires a plurality of images for learning and ground truth values corresponding to the plurality of images for learning, respectively, at a time. In the application process, the acquisition unit 110 acquires an unknown image subject to the process. The embodiment is non-limiting as to the number of channels of the image. For example, the image may be an RGB image or a gray scale image.

The storage unit 120 stores the image acquired by the acquisition unit 110. The storage unit 120 also serves as a work area of the neural network processing unit 130, the learning unit 140, and the interpretation unit 150 or as a storage area for the parameter of the neural network.

The neural network processing unit 130 performs a process determined by the neural network. The neural network processing unit 130 includes an input layer processing unit 131 for performing a process corresponding to the input layer of the neural network, an intermediate layer processing unit 132 for performing a process corresponding to the intermediate layer, and an output layer processing unit 133 for performing a process corresponding to the output layer.

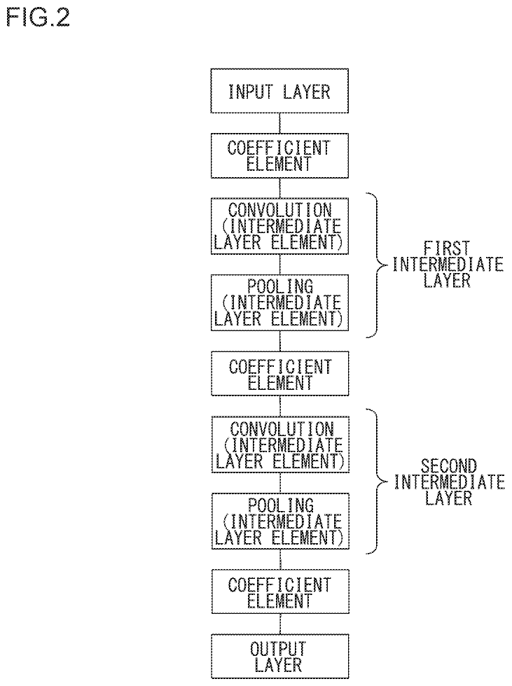

FIG. 2 schematically shows an example of the configuration of the neural network. In this example, the neural network includes two intermediate layers, each intermediate layer being configured to include an intermediate layer element for performing a convolutional process and an intermediate layer element for performing a pooling process. The embodiment is non-limiting as to the number of intermediate layers. For example, the number of intermediate layers may be 1 or 3 or more. In the case of the illustrated example, the intermediate layer processing unit 132 performs the process of each intermediate layer element of each intermediate layer.

In the embodiment, the neural network includes at least one coefficient element. In the illustrated example, the neural network includes coefficient elements before and after each intermediate layer. The intermediate layer processing unit 132 also performs a process corresponding to the coefficient element.

During the learning process, the intermediate layer processing unit 132 performs a coefficient process, which is a process corresponding to the coefficient element. A coefficient process is a process of multiplying intermediate data representing input data input to the intermediate layer element or representing output data from the intermediate layer element by a coefficient the absolute value of which increases monotonically (or monotically non-decreasing) in accordance with the progress of learning. In the coefficient process of the embodiment, the intermediate data is multiplied by a coefficient the absolute value of which increases monotonically in a range of 0 to 1 in accordance with the progress of learning. In the embodiment, the progress of learning is defined as the number of times that learning is repeated.

By way of example, the coefficient process is given by the following expression (1).

y=(1−α^{t})x (1)

x: input
y: output
α: hyper parameter defining the speed of amplification of the coefficient
t: number of repetition of learning

where α is set to a value larger than 0 and smaller than 1 (e.g., 0.999). Therefore, α^{t} becomes smaller gradually in the range larger than 0 and smaller than 1 as the learning progresses. Therefore, the coefficient (1−α^{t}) increases monotonically in the range larger than 0 and smaller than 1 as the learning progresses. In particular, the coefficient (1−α^{t}) approaches 1 as the learning progresses. In this case, the intermediate data is converted into a relatively small value in the initial phase of learning. As the learning progresses, the degree of conversion becomes smaller. In the latter phase of learning, conversion would appear as if the data is not substantially converted, as will be clear from the fact that a value close to 1 will be multiplied.

Further, the intermediate layer processing unit 132 performs the coefficient process given by the following expression (2) during the application process. In other words, the intermediate layer processing unit 132 performs a process of directly outputting the input as the output. To see it in an alternative perspective, it can be said that the intermediate layer processing unit 132 performs the coefficient process of multiplying by 1 during the application process. In any way, the application process can be performed in a processing time substantially equal to the time consumed when the embodiment is not used.

y=x (2)

The learning unit 140 trains the neural network by optimizing the optimization parameter of the neural network. The learning unit 140 calculates an error by using an objective function (error function) for comparing the output obtained by inputting the image for learning to the neural network processing unit 130 and the ground truth value corresponding to the image. The learning unit 140 calculates a gradient for the parameter by the gradient back propagation method, etc., based on the calculated error, and updates the optimization parameter of the neural network based on the momentum method.

The optimization parameter is optimized by repeating the acquisition of the image for learning by the acquisition unit 110, the process determined by the neural network performed on the image for learning by the neural network processing unit 130, and the update of the optimization parameter performed by the learning unit 140.

Further, the learning unit 140 determines whether learning should be terminated. The termination conditions for terminating learning may include: learning has been performed a predetermined number of times, an instruction for termination is received from outside, the average value of the amounts of update of the optimization parameter has reached a predetermined value, or the calculated error falls within a predetermined range. When the condition for termination is met, the learning unit 140 terminates the learning process. When the condition for termination is not met, the learning unit 140 returns the process to the neural network processing unit 130.

The interpretation unit 150 interprets the output from the output layer processing unit 133 to perform image categorization, object detection, or image segmentation.

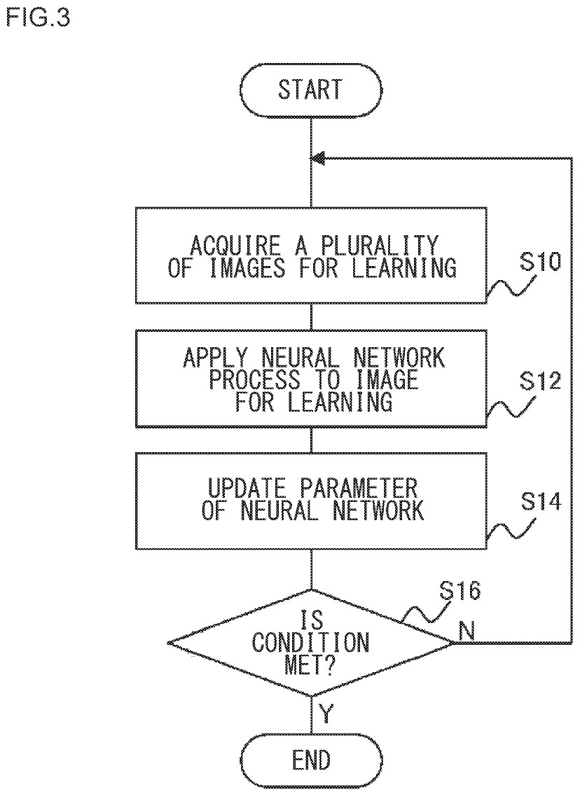

A description will be given of the operation of the data processing system 100 according to the embodiment. FIG. 3 is a flowchart showing the learning process performed by the data processing system 100. The acquisition unit 110 acquires a plurality of images for learning (S10). The neural network processing unit 130 subjects each of the plurality of images for learning acquired by the acquisition unit 110 to the process determined by the neural network and outputs respective output data (S12). The learning unit 140 updates the parameter based on the output data responsive to each of the plurality of images for learning and the ground truth for the respective images (S14). The learning unit 140 determines whether the condition for termination is met (S16). When the condition for termination is not met (N in S16), the process returns to S10. When the condition for termination is met (Y in S16), the process is terminated.

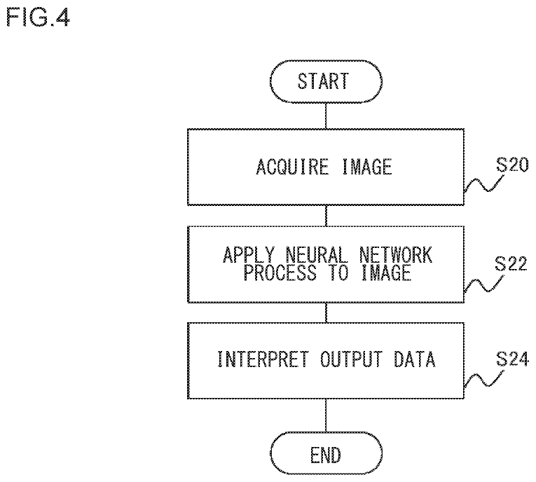

FIG. 4 is a flowchart showing the application process performed by the data processing system 100. The acquisition unit 110 acquires a plurality of target images subject to the application process (S20). The neural network processing unit 130 subjects each of the plurality of images for learning acquired by the acquisition unit 110 to the process determined by the neural network in which the optimization parameter is optimized, i.e., the trained neural network, and outputs output data (S22). The interpretation unit 150 interprets the output data to categorize the target image, detect an object in the target image, or subject the target image to image segmentation (S24).

The data processing system 100 according to the embodiment described above performs a coefficient process of multiplying intermediate data representing input data input to the intermediate layer element or representing output data from the intermediate layer element by a coefficient the absolute value of which increases monotonically in the range of 0 to 1 in accordance with the progress of learning. This inhibits the relationship between the input and the output of the neural network as a whole from changing significantly in the initial phase of learning and facilitates learning as a result. Further, the output of the coefficient process is prevented from becoming greater than the input to the coefficient process so that divergence of learning is inhibited.

Described above is an explanation of the present invention based on an exemplary embodiment. The embodiment is intended to be illustrative only and it will be understood by those skilled in the art that various modifications to combinations of constituting elements and processes are possible and that such modifications are also within the scope of the present invention.

### (Variation 1)

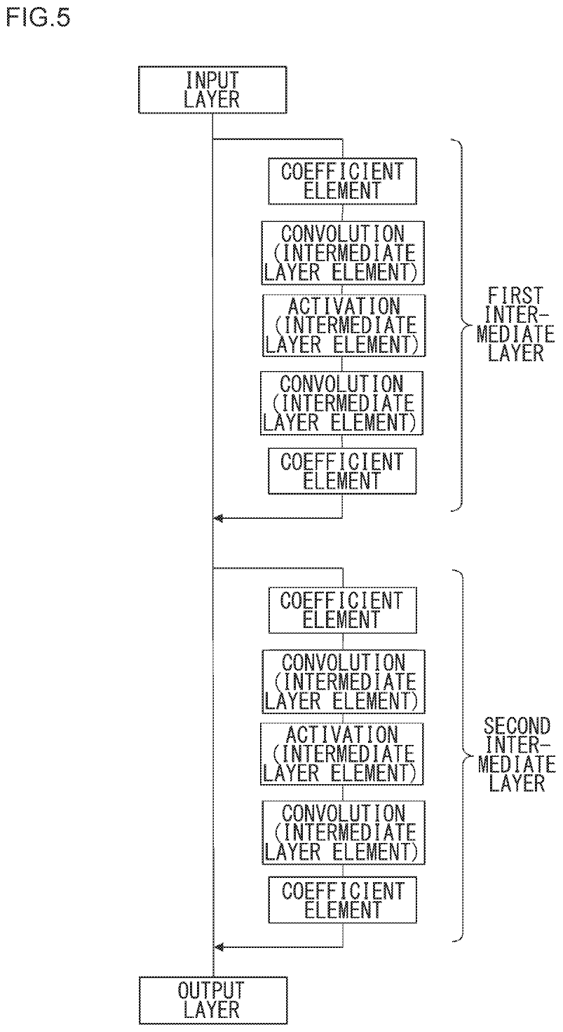

FIG. 5 schematically shows another example of the configuration of the neural network. In this example, the intermediate layer in the M-th layer (M is an integer equal to or larger than 1) includes one or more intermediate layer elements. In the process in the M-th layer, the neural network processing unit 130 subjects at least one of intermediate data representing the input data input to the intermediate layer element or intermediate data representing the output data from the intermediate layer element to the coefficient process. In the illustrated example, the neural network processing unit 130 subjects intermediate data representing the input data input to the first intermediate layer element of the one or more intermediate layer elements constituting the intermediate layer in the M-th layer and intermediate data representing the output data from the last intermediate layer element to a coefficient process.

The neural network processing unit 130 also performs an integration process of integrating intermediate data that should be input to the intermediate layer in the M-th layer and further intermediate data output by inputting the intermediate data to the intermediate layer in the M-th layer. For example, the neural network processing unit 130 may add, in the integration process, intermediate data that should be input to the intermediate layer in the M-th layer and further intermediate data output by inputting the intermediate data to the intermediate layer in the M-th layer to each other. The neural network in this case represents a residential network that incorporates a coefficient element. Still alternatively, the neural network processing unit 130 may subject, in the integration process, intermediate data that should be input to the intermediate layer in the M-th layer and further intermediate data output by inputting the intermediate data to the intermediate layer in the M-th layer to channel connection. The neural network in this case represents a densely connected network that incorporates a coefficient element.

According to this variation, the relationship between the input and the output of the neural network as a whole will resemble identity mapping so that learning is facilitated. More specifically, when the intermediate data representing the input data input to the first intermediate layer element of the one or more intermediate layer elements constituting the intermediate layer in the M-th layer is subject to the coefficient process, the forward propagation will resemble identity mapping. When the intermediate data representing the output data from the last intermediate layer element is subject to the coefficient process, the backward propagation will resemble identity mapping.

### (Variation 2)

When the coefficient approaches 1 sufficiently in the coefficient process, i.e., when the difference between 1 and the coefficient becomes equal to or smaller than a predetermined value, the coefficient may not be multiplied any longer. More specifically, the coefficient process may be given by the following expression (3).

$$y = \{ \begin{matrix}( 1 - {α}^{t} ) x … {α}^{t} > ɛ \\ x … {α}^{t} \leq ɛ\end{matrix}$$

ε: hyper parameter defining the degree of disregarding multiplication by coefficient

As described above, α^{t} becomes smaller gradually in the range of 0 to 1 as the learning progresses. The coefficient (1−α^{t}) approaches 1 in the range of 0 to 1 as the learning progresses. In this variation, the process of outputting the input directly without multiplying the input by the coefficient is performed when the coefficient (1−α^{t}) approaches 1 to a certain degree or more, i.e., when the difference between 1 and the coefficient (1−α^{t}) becomes smaller than ε. According to the variation, the learning process can be performed in a processing time substantially equal to the time consumed when the variation is not used, in the middle of learning and afterwards.

### (Variation 3)

In the embodiment, the progress of learning is described as being defined as the number of times that learning is repeated, but the embodiment is non-limiting as to the definition of the progress of learning. For example, the progress of learning may be defined as the degree of convergence of learning. In this case, the progress may be a value based on a function that decreases monotonically with respect to the difference between the output obtained by inputting the learning data to the neural network and the ground truth, which is the ideal output data for the learning data. More specifically, the progress may be a value based on the following expression (4).

$$t = \frac{1}{L} \qquad ( 4 )$$

L: value of an error calculated by the objective function (error function) for comparing the output obtained by inputting the image for learning to the neural network processing unit 130 and the ground truth corresponding to the image

In the embodiment and the variations, the data processing system may include a processor and a storage such as a memory. The functions of the respective parts of the processor may be implemented by individual hardware, or the functions of the parts may be implemented by integrated hardware. For example, the processor could include hardware, and the hardware could include at least one of a circuit for processing digital signals or a circuit for processing analog signals. For example, the processor may be configured as one or a plurality of circuit apparatuses (e.g., IC, etc.) or one or a plurality of circuit devices (e.g., a resistor, a capacitor, etc.) packaged on a circuit substrate. The processor may be, for example, a central processing unit (CPU). However, the processor is not limited to a CPU. Various processors may be used. For example, a graphics processing unit (GPU) or a digital signal processor (DSP) may be used. The processor may be a hardware circuit comprised of an application specific integrated circuit (ASIC) or a field-programmable gate array (FPGA). Further, the processor may include an amplifier circuit or a filter circuit for processing analog signals. The memory may be a semiconductor memory such as SRAM and DRAM or may be a register. The memory may be a magnetic storage apparatus such as a hard disk drive or an optical storage apparatus such as an optical disk drive. For example, the memory stores computer readable instructions. The functions of the respective parts of the data processing system are realized as the instructions are executed by the processor. The instructions may be instructions of an instruction set forming the program or instructions designating the operation of the hardware circuit of the processor.

What is claimed is:

1. A data processing system comprising: a processor comprising hardware, wherein the processor outputs, by subjecting learning data to a process determined by a neural network, output data responsive to the learning data, the neural network including an input layer, one or more intermediate layers, and an output layer, wherein
the processor is configured to train the neural network based on a comparison between the output data responsive to the learning data and ideal output data for the learning data, and wherein
training of the neural network is optimization of an optimization parameter of the neural network, and
training of the neural network includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

2. A data processing system comprising: a processor comprising hardware, wherein the processor performs a process determined by a neural network including an input layer, one or more intermediate layers, and an output layer, wherein
an optimization parameter of the neural network is optimized during training of the neural network based on a comparison between output data output when learning data is subject to the process and ideal output data for the learning data, and
the training of the neural network includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

3. The data processing system according to claim 1, wherein
the absolute value of the coefficient is not smaller than 0 and not larger than 1.

4. The data processing system according to claim 1, wherein
the processor outputs the input directly in the coefficient process, when a difference between 1 and the coefficient becomes equal to or smaller than a predetermined value.

5. The data processing system according to claim 1, wherein
during an application process, the processor outputs the input directly in the coefficient process.

6. The data processing system according to claim 1, wherein
the intermediate layer in the M-th layer includes one or more intermediate layer elements, and
the processor is configured to:
(i) subject, in a process in the intermediate layer in the M-th layer, one or both of the intermediate data representing the input data input to the intermediate layer element and the intermediate data representing the output data from the intermediate layer element to the coefficient process; and
(ii) perform an integration process of integrating intermediate data that should be input to the intermediate layer in the M-th layer and further intermediate data output by inputting the intermediate data to the intermediate layer in the M-th layer.

7. The data processing system according to claim 6, wherein
the processor is configured to:
subject intermediate data representing input data input to the first intermediate layer element of the intermediate layer in the M-th layer to the coefficient process.

8. The data processing system according to claim 6, wherein
the processor is configured to:
subject intermediate data representing output data from the last intermediate layer element of the intermediate layer in the M-th layer to the coefficient process.

9. The data processing system according to claim 6, wherein
the processor is configured to:
add, in the integration process, the intermediate data representing the input data input to the intermediate layer element and the intermediate data representing the output data from the intermediate layer element.

10. The data processing system according to claim 6, wherein
the processor is configured to:
subject, in the integration process, the intermediate data representing the input data input to the intermediate layer element and the intermediate data representing the output data from the intermediate layer element to channel connection.

11. The data processing system according to claim 1, wherein
the progress of learning is defined as the number of times that learning is repeated.

12. The data processing system according to claim 1, wherein
the progress of learning is determined based on a function that decreases monotonically with respect to a difference between output data output by subjecting the learning data to the process and ideal output data for the learning data.

13. A data processing method comprising:
outputting, by subjecting learning data to a process determined by a neural network, output data responsive to the learning data, the neural network including an input layer, one or more intermediate layers, and an output layer; and
training the neural network based on a comparison between the output data responsive to the learning data and ideal output data for the learning data, wherein
training of the neural network is optimization of an optimization parameter of the neural network, and
training of the neural network includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

14. A data processing method comprising:
performing a process determined by a neural network including an input layer, one or more intermediate layers, and an output layer, wherein
an optimization parameter of the neural network is optimized during training of the neural network based on a comparison between output data output when learning data is subject to the process and ideal output data for the learning data, and
the training of the neural network includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

15. A non-transitory computer readable medium encoded with a program executable by a compute, the program comprising:
outputting, by subjecting learning data to a process determined by a neural network, output data responsive to the learning data, the neural network including an input layer, one or more intermediate layers, and an output layer; and
training the neural network based on a comparison between the output data responsive to the learning data and ideal output data for the learning data, wherein
training of the neural network is optimization of an optimization parameter of the neural network, and
training of the neural network includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.

16. A non-transitory computer readable medium encoded with a program executable by a compute, the program comprising:
performing a process determined by a neural network including an input layer, one or more intermediate layers, and an output layer, wherein
an optimization parameter of the neural network is optimized during training of the neural network based on a comparison between output data output when learning data is subject to the process and ideal output data for the learning data, and
training of the neural network includes performing a coefficient process of multiplying intermediate data representing input data input to an intermediate layer element constituting the intermediate layer of an M-th layer (M is an integer equal to or larger than 1) or representing output data from the intermediate layer element by a coefficient the absolute value of which increases monotonically in accordance with progress of learning.
